(19) United States
(12) Patent Application Publication
(10) Pub. No.: US 2021/0020142 A1
(43) Pub. Date: Jan. 21, 2021

(54) INFORMATION PROCESSING DEVICE, INFORMATION PROCESSING METHOD, AND PROGRAM

(71) Applicant: SONY CORPORATION, Tokyo (JP)

(72) Inventors: Tomohiro OOI, Chiba (JP); Koji FURUSAWA, Tokyo (JP); Hiroshi YAMAGUCHI, Tokyo (JP); Satoshi SUZUKI, Tokyo (JP)

(73) Assignee: SONY CORPORATION, Tokyo (JP)

(21) Appl. No.: 16/980,077

(22) PCT Filed: Mar. 6, 2019
(86) PCT No.: PCT/JP2019/008729

§ 371 Date: Sep. 11, 2020

(30) Foreign Application Priority Data
Mar. 20, 2018 (JP) 2018-051954

(51) Int. Cl. G09G 5/32; G09G 5/38

(52) U.S. Cl. CPC G09G 5/32; G09G 5/38; G09G 2340/0464; G09G 2340/14; G09G 2340/125

(57) ABSTRACT

There is provided an information processing device, an information processing method, and a program that enable a character string to be displayed at an optimal position. The control unit controls display of a character string represented by text information related to an object included in a content image displayed in a display area. The control unit determines the arrangement area in which the character string is arranged in the display area, on the basis of a position of the object with respect to the display area. The present technology can be applied to, for example, a display device for VR.

### TECHNICAL FIELD

The present technology relates to an information processing device, an information processing method, and a program, and particularly relates to an information processing device, an information processing method, and a program that enable a character string to be displayed at an optimal position.

### BACKGROUND ART

Virtual reality (VR) technology for presenting information to the user by displaying in a virtual space and augmented reality (AR) technology for presenting additional information to the user by superimposing and displaying in a real space are known.

In recent years, head-mounted displays (HMDs), head-up displays (HUDs), and the like have become widespread as display devices using the VR technology and the AR technology. With such a display device, the user can watch content such as video by freely changing a view point.

On the other hand, for example, Patent Document 1 discloses a technique of arranging text information in accordance with the position of the line of sight of the user in a display area.

### CITATION LIST

### Patent Document

### Patent Document 1: Japanese Patent Application Laid-Open No. 2014-215604

### SUMMARY OF THE INVENTION

### Problems to be Solved by the Invention

For example, in an HMD for VR, when a user watches a video including a character string such as a subtitle, an object in the video may be hidden by characters depending on the arrangement of the character string.

The present technology has been made in view of such a situation, and makes it possible to display a character string at an optimal position.

### Solutions to Problems

An information processing device of the present technology includes a control unit that controls display of a character string represented by text information related to an object included in a content image displayed in a display area, in which the control unit determines an arrangement area in which the character string is arranged in the display area, on the basis of a position of the object with respect to the display area.

An information processing method of the present technology is a method including, by an information processing device, controlling display of a character string represented by text information related to an object included in a content image displayed in a display area, and determining an arrangement area in which the character string is arranged in the display area, on the basis of a position of the object with respect to the display area.

A program of the present technology is a program causing a computer to execute controlling display of a character string represented by text information related to an object included in a content image displayed in a display area, and determining an arrangement area in which the character string is arranged in the display area, on the basis of a position of the object with respect to the display area.

In the present technology, display of a character string represented by text information related to an object included in a content image displayed in a display area is controlled, and an arrangement area in which the character string is arranged is determined in the display area, on the basis of a position of the object with respect to the display area.

### Effects of the Invention

According to the present technology, it is possible to display a character string at an optimal position.

Note that the effect described here is not necessarily limited, and may be any one of the effects described in the present disclosure.

### BRIEF DESCRIPTION OF DRAWINGS

FIG. 1 is a diagram illustrating an external configuration of an HMD to which technology according to the present disclosure is applied.

FIG. 2 is a block diagram illustrating a configuration example of an HMD as an information processing device.

FIG. 3 is a block diagram illustrating a functional configuration example of the HMD.

FIG. 4 is a flowchart describing character string arrangement process.

FIG. 5 is a diagram describing arrangement of character strings in a display area.

FIG. 6 is a diagram describing arrangement of character strings in the display area.

FIG. 7 is a diagram describing a first display example.

FIG. 8 is a diagram describing the first display example.

FIG. 9 is a diagram describing the first display example.

FIG. 10 is a diagram describing a second display example.

FIG. 11 is a diagram describing the second display example.

FIG. 12 is a diagram describing a third display example.

FIG. 13 is a diagram describing the third display example.

FIG. 14 is a diagram describing a fourth display example.

FIG. 15 is a diagram describing the fourth display example.

FIG. 16 is a block diagram illustrating another functional configuration example of the HMD.

FIG. 17 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.

1. Configuration and operation of HMD to which technology according to the present disclosure is applied

2. First display example (display example according to movement of visual field)

3. Second display example (display example according to movement of object)

4. Third display example (display example according to objects located outside display area)

5. Fourth display example (display switching example)

6. Others

### 1. Configuration and Operation of HMD to which Technology According to the Present Disclosure is Applied

(External Configuration of HMD)

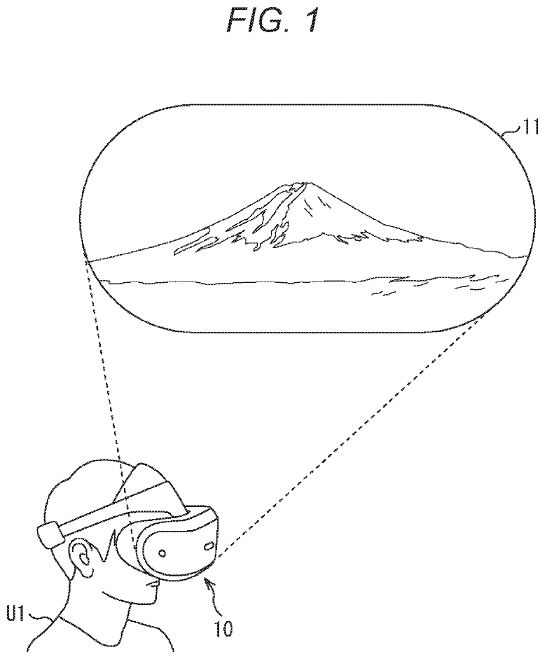

FIG. 1 is a diagram illustrating an external configuration of an HMD to which technology according to the present disclosure is applied.

FIG. 1 illustrates an HMD 10 mounted on the head of a user U1.

The HMD 10 is configured as a display device for VR and includes a non-transmitting display 11. A video (hereinafter, also referred to as a content image) selected for watching by the user is displayed on the display 11.

In a case where the content image is a still image, an object (physical object, person, or the like) included in the content image changes in position with respect to a display area of the display 11 by the user U1 moving the visual field.

In a case where the content image is a moving image, an object included in the content image changes in position with respect to the display area according to time, or changes in position with respect to the display area of the display 11 when the user U1 moves his or her visual field.

The visual field (range visible to eyes) of the user U1 in the VR space moves when the user U1 wearing the HMD 10 on the head changes the direction of the head. On the other hand, if the user U1 moves his or her line of sight without changing the direction of the head, the visual field of the user U1 in the VR space does not move.

In the example of FIG. 1, the display 11 displays a content image including a “mountain” as an object.

When a subtitle (caption) that describes about the “mountain” is superimposed and displayed on this content image as a character string related to the “mountain”, it is preferred that the caption be placed near the center of the display area for readability. However, in a case where the “mountain” is located at the center of the display area, the “mountain” may be hidden by the characters.

Accordingly, it is possible to fix the position and size of the area where the subtitle is displayed with respect to the “mountain” of the content image. However, in a case where the user moves the visual field or the number of characters displayed in real time as subtitles changes, or the like, if the position and size of the area where the subtitle is displayed are fixed, it is possible that necessary information is not transmitted to the user.

On the other hand, the HMD 10 to which the technology according to the present disclosure is applied is configured to display the character string at an optimal position in the content image.

(Configuration Example of HMD as Information Processing Device)

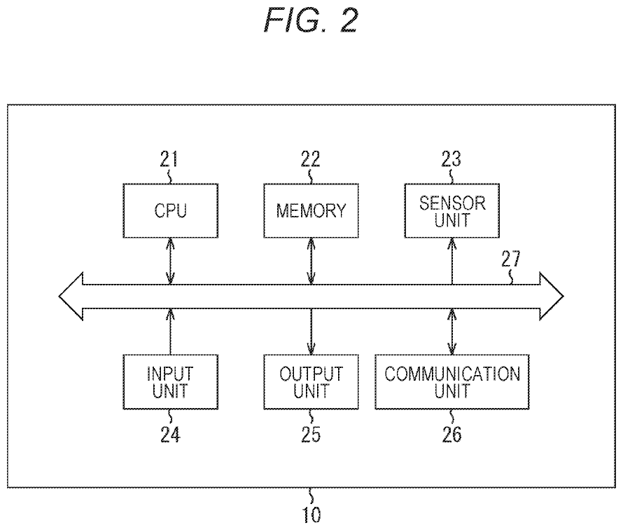

FIG. 2 is a block diagram illustrating a configuration example of an HMD 10 as an information processing device to which the technology according to the present disclosure is applied.

The HMD 10 in FIG. 2 includes a central processor unit (CPU) 21, a memory 22, a sensor unit 23, an input unit 24, an output unit 25, and a communication unit 26. These are connected to each other via a bus 27.

The CPU 21 executes processing for implementing various functions included in the HMD 10 according to programs, data, and the like stored in the memory 22.

The memory 22 includes a storage medium such as a semiconductor memory or a hard disk, and stores programs and data for processing by the CPU 21.

The sensor unit 23 includes various sensors such as an image sensor, a microphone, a gyro sensor, and an acceleration sensor. Various kinds of sensor information obtained by the sensor unit 23 are also used for processing by the CPU 21.

The input unit 24 includes buttons, keys, a touch panel, and the like. The output unit 25 includes the display 11, the speaker, and the like of FIG. 1. The communication unit 26 is configured as a communication interface that intermediates various types of communication.

(HMD Functional Configuration Example)

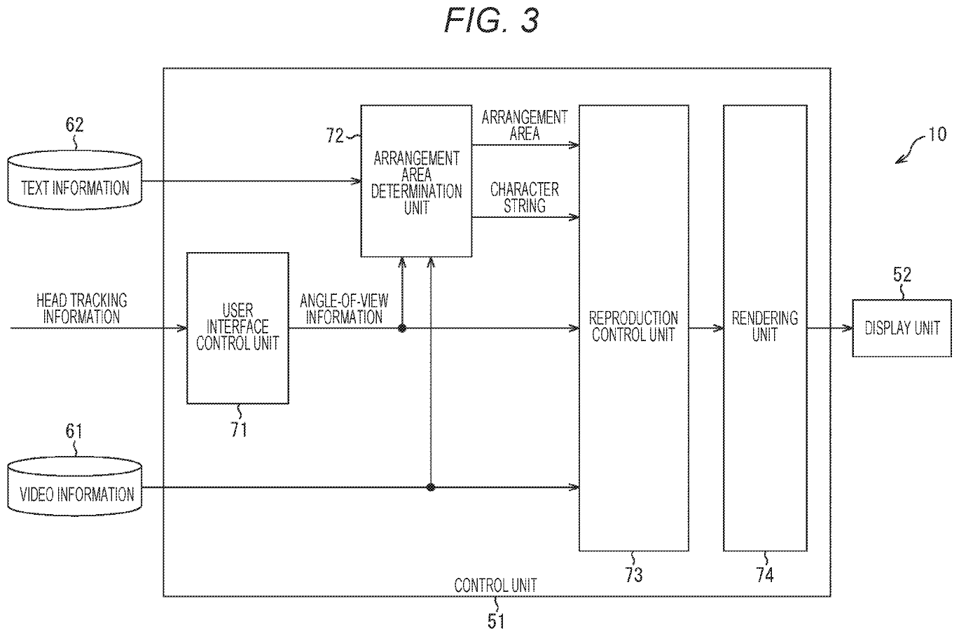

FIG. 3 is a block diagram illustrating a functional configuration example of the HMD 10.

The HMD 10 in FIG. 3 includes a control unit 51 and a display unit 52.

The control unit 51 obtains video information 61 and displays a video (content image) represented by the video information 61 on the display unit 52 corresponding to the display 11 in FIG. 1. The video information 61 is assumed to be recorded in the memory 22 in FIG. 2, but may be obtained from a server on the network, or the like via the communication unit 26.

Furthermore, the control unit 51 obtains text information 62, and superimposes and displays a character string represented by the text information 62 on a content image displayed in a display area of the display unit 52. At this time, the control unit 51 determines the arrangement area in which the character string is arranged in the display area on the basis of the position of an object included in the content image with respect to the display area.

The text information 62 is information related to the object included in the content image represented by the video information 61, and is recorded in the memory 22 in association with the video information 61. For example, in a case where the object is a physical object, the character string represented by the text information 62 is a sentence that describes the material object. In a case where the object is a person, the character string represented by the text information 62 is a sentence indicating a conversation (speech content) of the person. In addition to this, the character string represented by the text information 62 may be a character string that is displayed as a subtitle and indicates the title, telop, or narration of the content image.

Moreover, the control unit 51 controls display of the content image and the character string in the display area of the display unit 52 on the basis of head tracking information obtained as sensor information by the sensor unit 23 of FIG. 2. The head tracking information is information indicating a direction of the head of the user U1 wearing the HMD 10.

The control unit 51 includes a user interface control unit 71, an arrangement area determination unit 72, a reproduction control unit 73, and a rendering unit 74.

Each functional block configuring the control unit 51 can be configured in terms of hardware by the CPU 21, the memory 22, and other large scale integration (LSI) not illustrated, which are included in the HMD 10. Furthermore, these functional blocks can be implemented in terms of software as a program loaded in the memory 22, or the like.

The user interface control unit 71 generates angle-of-view information indicating the angle of view of a content image displayed in the display area on the basis of the head tracking information from the sensor unit 23. The angle of view of the content image determines the visual field of the user U1 in the VR space, and changes depending on the direction (angle) of the head of the user U1. The generated angle-of-view information is supplied to the arrangement area determination unit 72 and the reproduction control unit 73.

The arrangement area determination unit 72 determines the position and shape of the arrangement area in which a character string represented by the text information 62 is placed in the display area on the basis of the video information 61, the text information 62, and the angle-of-view information from the user interface control unit 71.

The text information 62 includes information indicating a character string displayed in the display area, information indicating a character font, and position information indicating a position that can be determined as the arrangement area in the display area. Moreover, the text information 62 includes priority information indicating priority of the position information (positions that can be determined as the arrangement area).

That is, the arrangement area determination unit 72 uses the position information and the priority information included in the text information 62 to find the more optimal position of arrangement area in the content image represented by the video information 61.

Here, a more optimal position of arrangement area is, for example, a position avoiding a target (object) that is desired to be not hidden in the content image, a position near a person who is talking (speaking), a position where the user can visually recognize the character string (can read the characters) in the display area, or the like.

Moreover, the arrangement area determination unit 72 determines the shape of the arrangement area on the basis of the positional relationship between the determined arrangement area and the object in the display area.

The information indicating the arrangement area whose position and shape are determined as described above is supplied to the reproduction control unit 73 together with the information indicating the character string.

The reproduction control unit 73 decodes the content image represented by the video information 61. The decoded content image is supplied to the rendering unit 74.

Here, when the size of the content image is larger than the size of the display area, the reproduction control unit 73 cuts out an image of a range to be displayed in the display area of the display unit 52 from the decoded content image on the basis of the angle-of-view information from the user interface control unit 71.

Furthermore, when supplying the decoded content image to the rendering unit 74, the reproduction control unit 73 synchronizes the content image with the information indicating the arrangement area from the arrangement area determination unit 72 and the information indicating the character string.

The rendering unit 74 generates a content image in which a character string is arranged (superimposed and displayed) in the arrangement area on the basis of the content image, the information indicating the arrangement area, and the information indicating the character string from the reproduction control unit 73, and displays the content image in the display area of the display unit 52.

With such a configuration, the character string is displayed at the optimal position in the content image.

(Character String Arrangement Process)

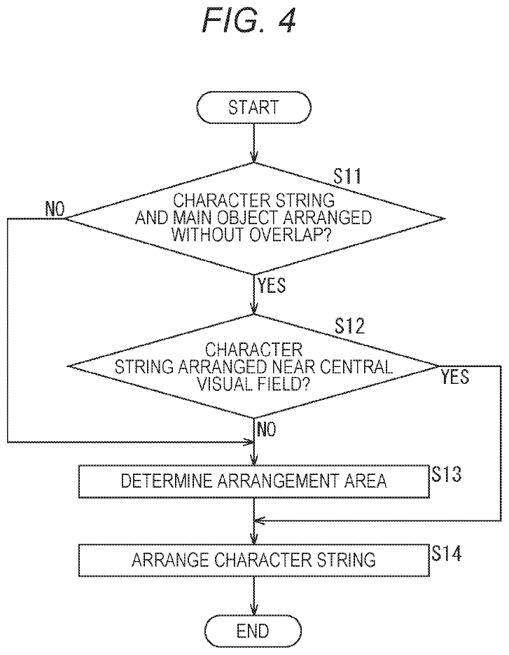

Here, a character string arrangement process by the HMD 10 will be described with reference to a flowchart in FIG. 4. The process in FIG. 4 is repeatedly executed while a content image is displayed. In the content image, it is assumed that the position of an object with respect to the display area of the display unit 52 changes as the user moves his or her visual field and according to time.

In step S11, the arrangement area determination unit 72 determines whether or not a character string (for example, a subtitle) that describes a main object in the content image does not overlap the main object. The main object is the object that attracts most attention among objects included in the content image.

In step S11, when it is determined that the character string and the main object do not overlap, the process proceeds to step S12, and the arrangement area determination unit 72 determines whether or not the character string is arranged near a central visual field in the display area.

Generally, the human eye has a lower resolution and more difficulty in recognizing small information such as characters in a more peripheral side of the entire area of its visual field. Therefore, in the display area of the display unit 52, it is necessary to arrange small information such as characters within a certain range with reference to the center of the visual field of the user. Accordingly, a certain range with reference to the center of the display area is defined as the central visual field in which the user can read characters. Furthermore, a range outside the central visual field in the display area is defined as a peripheral visual field.

When it is determined in step S12 that the character string is arranged near the central visual field, step S13 is skipped and the process proceeds to step S14.

In step S14, the reproduction control unit 73 and the rendering unit 74 arrange the character strings in the content image displayed in the display area, with the vicinity of the central visual field being the arrangement area.

On the other hand, when it is determined in step S11 that the character string and the main object overlap, the process proceeds to step S13, and the arrangement area determination unit 72 determines the arrangement area so that the character string does not overlap the main object.

Moreover, also when it is determined in step S12 that the subtitle is not arranged near the central visual field, the process proceeds to step S13, and the arrangement area determination unit 72 determines the arrangement area so that the character string is arranged near the central visual field. Here, the arrangement area may be arranged inside the central visual field, or a part of the arrangement area may be arranged so as to overlap the central visual field.

After step S13, the process proceeds to step S14, and the reproduction control unit 73 and the rendering unit 74 arrange the character string in the determined arrangement area in the content image displayed in the display area.

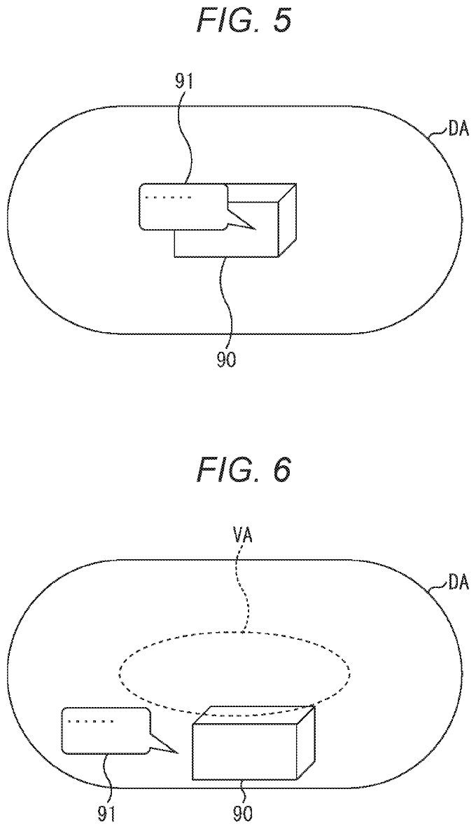

Thus, as illustrated in FIG. 5 for example, when moving of the object 90 in the display area DA causes the object 90 to overlap the balloon 91 (arrangement area) in which the character string is displayed, the balloon 91 is moved and displayed so as to avoid the object 90.

Furthermore, as illustrated in FIG. 6, when moving of the object 90 within the display area DA causes the balloon 91 to be arranged at a position outside the central visual field VA in the display area DA, the balloon 91 is moved and displayed near the central visual field VA.

By the above process, since the arrangement area is determined on the basis of the position of the object with respect to the display area, it is possible to display a character string at an optimal position without hiding the object with characters or failing in transmitting necessary information to the user.

Hereinafter, a specific display example of a content image on the HMD 10 described above will be described.

### 2. First Display Example

When the user wearing the HMD 10 changes the direction of the head in order to move the visual field with respect to the content image, the object moves in the display area. A display example in this case will be described.

### Conventional Example 1

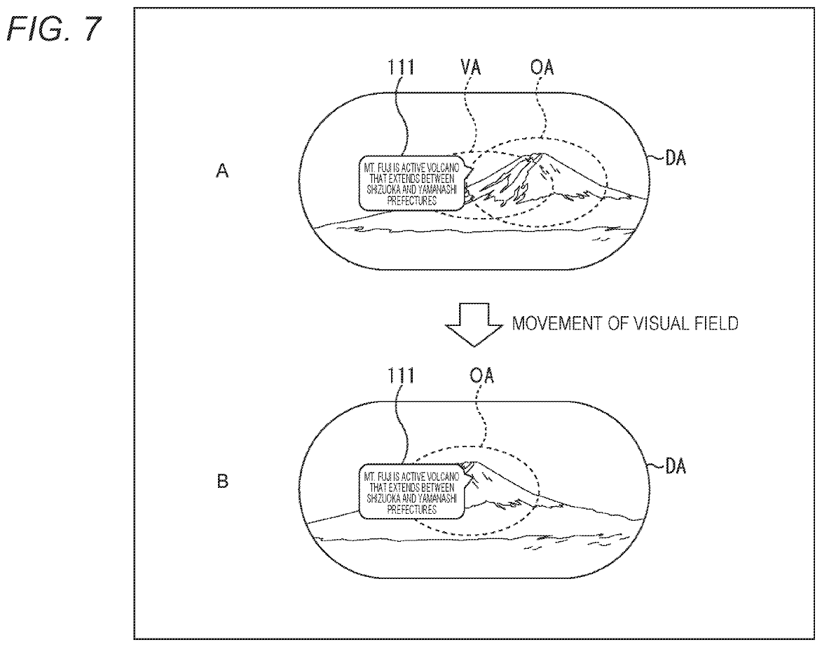

FIG. 7 is a diagram describing a display example of a content image on a conventional HMD.

In A of FIG. 7, a state is illustrated in which a content image including “mountain” as an object is displayed in the display area DA.

In A of FIG. 7, a central visual field VA of the display area DA and an area (hereinafter, referred to as an object area) OA where an object exists are illustrated by broken lines. The object area OA is an area where overlap of a character string such as a subtitle is not desired. The object area OA (“mountain” as an object) is displayed on a right side of the center of the display area DA.

Furthermore, in A of FIG. 7, a balloon 111 displaying a character string “Mt. Fuji is an active volcano that extends between Shizuoka and Yamanashi prefectures” that describes the object in the object area OA is displayed in the display area DA. The balloon 111 is arranged on a left side of the object area OA, at a position avoiding the object area OA and at a position overlapping the central visual field VA.

In the example of FIG. 7, it is assumed that the position of the balloon 111 is fixed within the display area DA.

When the user turns his or her head rightward from a state in A of FIG. 7 in order to move the visual field, the object area QA moves leftward in the display area DA and is located at the center of the display area DA as illustrated in B of FIG. 7.

At this time, since the position of the balloon 111 is fixed, the balloon 111 overlaps the object area OA, and the “mountain” that is the object is hidden by the balloon 111.

### Conventional Example 2

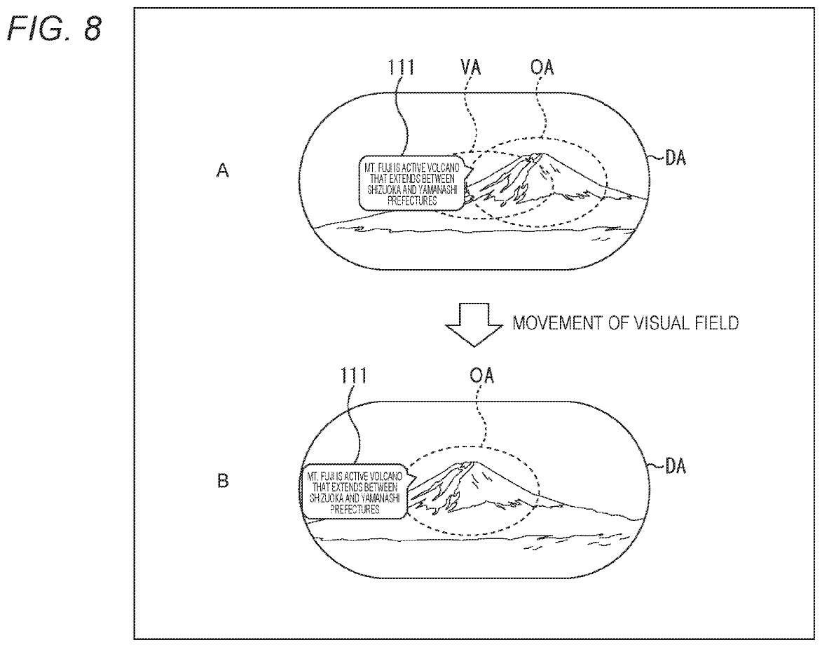

FIG. 8 is also a diagram describing a display example of a content image on a conventional HMD.

A of FIG. 8 illustrates a state similar to A of FIG. 7.

In an example of FIG. 8, it is assumed that the position of the balloon 111 moves in the display area DA in accordance with the movement of the visual field of the user.

When the user turns his or her head rightward from a state in A of FIG. 8 in order to move the visual field, the object area QA moves leftward in the display area DA and is located at the center of the display area DA as illustrated in B of FIG. 8.

At this time, the position of the balloon 111 becomes close to a left end of the display area DA by moving according to movement of the visual field of the user in the display area DA. That is, the balloon 111 comes to be located in a peripheral visual field of the user, and it becomes difficult to read the character.

(Example of the Present Technology)

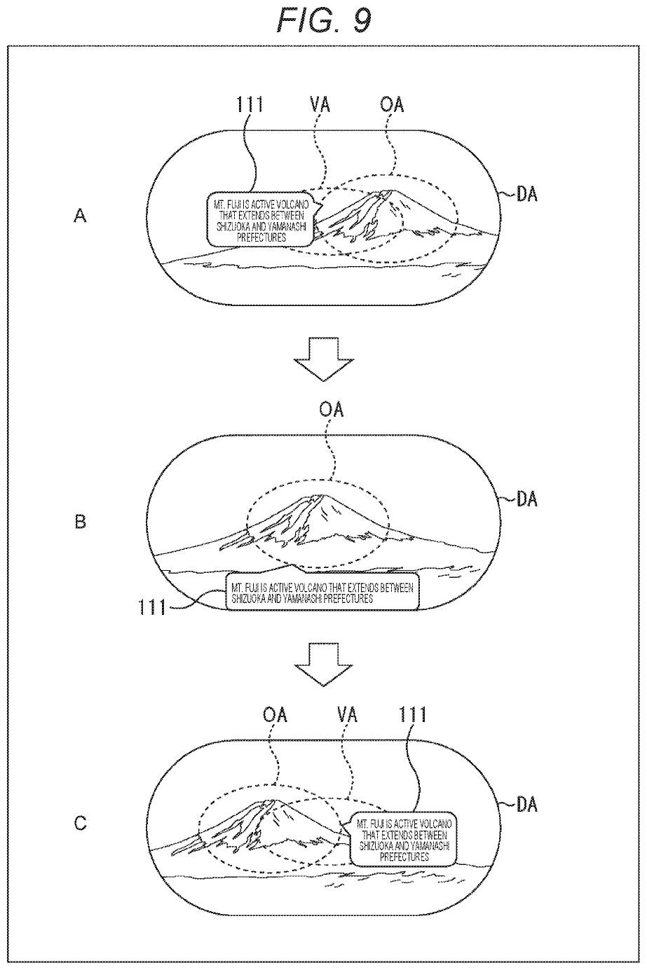

FIG. 9 is a diagram describing a display example of a content image on the HMD 10 of the present technology.

A of FIG. 9 illustrates a state similar to A of FIG. 7.

When the user turns his or her head rightward from a state in A of FIG. 9 in order to move the visual field, the object area OA moves leftward in the display area DA and is located at the center of the display area DA as illustrated in B of FIG. 9.

At this time, the balloon 111 (arrangement area) moves so as to be arranged below the object area OA, so as to avoid the object area OA and to be closer to the central visual field of the user.

Furthermore, the shape of the balloon 111 is adapted to change according to the position of the object area OA. For example, when the object area OA is located near the central visual field of the user, the shape of the balloon 111 is changed so as to avoid the object area OA.

In B of FIG. 9, the shape of the balloon 111 has changed to a horizontally long rectangular shape from the state in A of FIG. 9, and the number of lines of the text displayed in the balloon 111 (character string arranged in the arrangement area) according to the shape has changed from three to two.

When the user further turns his or her head rightward from a state in B of FIG. 9 in order to move the visual field, the object area OA moves further leftward in the display area DA and is located on a left side of the center in the display area DA, as illustrated in C of FIG. 9.

At this time, the balloon 111 moves so as to be arranged on a right side of the object area OA at a position avoiding the object area OA and at a position overlapping the central visual field VA.

Furthermore, the shape of the balloon 111 has changed from the state in B of FIG. 9 to a shape similar to the state in A, and the number of lines of the sentence displayed in the balloon 111 has changed from two to three according to the shape.

That is, in the example of FIG. 9, in the display area DA, the position of the balloon 111 with respect to the object area OA moves in a direction opposite to the direction in which the object area CA moves from right to left, that is, from left to right.

In this manner, even when the user changes the direction of the head to move the object in the display area, it is possible to display the character string at the optimal position without hiding the object with characters or failing in transmitting necessary information to the user.

Note that without being limited to the example of FIG. 9, the position of the balloon 111 (arrangement area) can be moved in the direction opposite to the moving direction of the object area OA. For example, when the object area OA moves from left to right in the display area DA, the position of the arrangement area is moved from right to left. Furthermore, when the object area OA moves from top to bottom in the display area DA, the position of the arrangement area may be moved from bottom to top.

### 3. Second Display Example

In a case where a content image (video) is a drama or the like in which a person who appears is an object, the object moves in the display area. A display example in this case will be described.

### Conventional Example

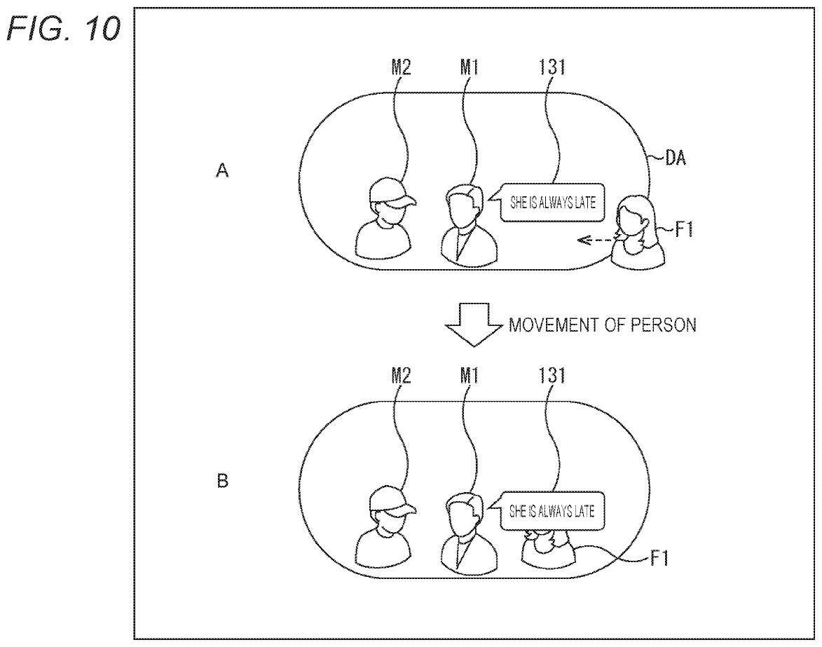

FIG. 10 is a diagram describing a display example of a content image on a conventional HMD.

A of FIG. 10 illustrates that one scene of a drama in which two persons M1, M2 appear as objects is displayed as a content image in the display area DA.

In A of FIG. 10, the person M1 is displayed near a center of the display area DA, and the person M2 is displayed on a left side of the person M1.

Furthermore, in A of FIG. 10, a balloon 131 displaying a sentence “She is always late” representing a conversation of the person M1 is displayed is displayed in the display area DA. The balloon 131 is arranged on a right side of the person M1.

In the example of FIG. 10, it is assumed that the position of the balloon 131 is fixed within the display area DA.

When a person F1 as an object moves so as to approach the person M1 from the outside of the display area DA to the inside of the display area DA from a state in A of FIG. 10, the person F1 is located on a right side of the person M1 as illustrated in B of FIG. 10.

At this time, since the position of the balloon 131 is fixed, the balloon 131 overlaps the person F1 and the face of the person F1 as an object is hidden by the balloon 131. As a result, facial expression of the person F1 is no longer visible.

(Example of the Present Technology)

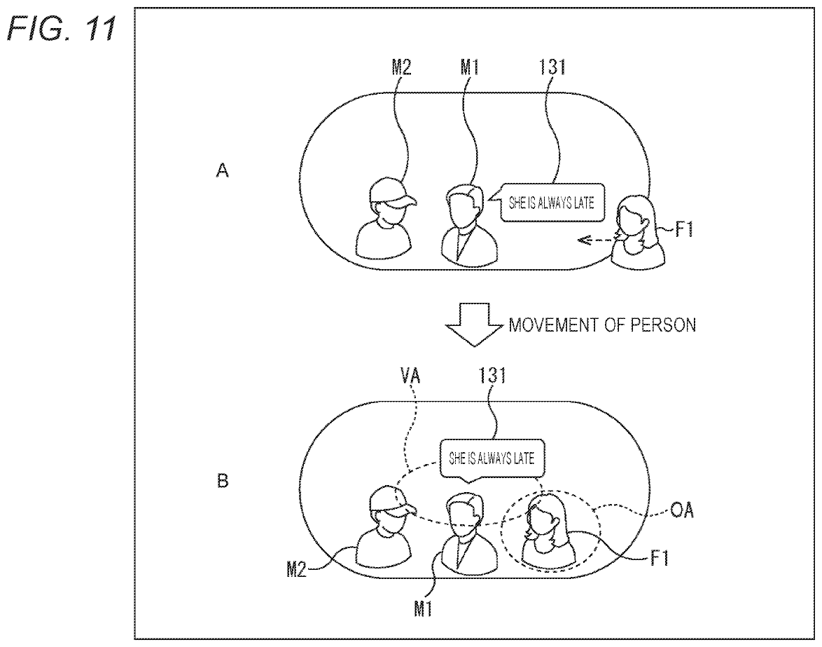

FIG. 11 is a diagram describing a display example of a content image on the HMD 10 of the present technology.

A of FIG. 11 illustrates a state similar to A of FIG. 10.

When the person F1 as an object moves so as to approach the person M1 from outside the display area DA to inside the display area DA from a state in A of FIG. 11, the person F1 is located on a right side of the person M1 as illustrated in B of FIG. 11.

At this time, the balloon 131 moves so as to be arranged above the person M1 so as to avoid the area of the person F1 (object area OA), particularly the face of the person F1 and to overlap the central visual field VA of the user.

Thus, even when an object (person) moves from outside the display area to inside the display area, it is possible to display a character string at the optimal position without hiding the object by characters.

### 4. Third Display Example

In a case where the content image (video) is a drama or the like in which a performer is an object, it is possible that part of people is located outside the display area depending on the visual field of the user. A display example in this case will be described.

### Conventional Example

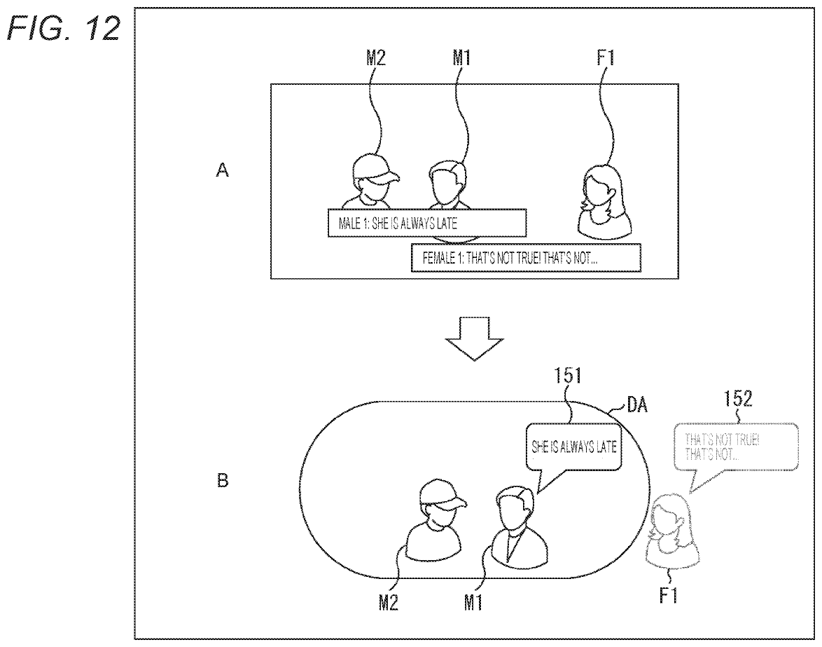

FIG. 12 is a diagram describing a display example of a content image on a conventional HMD.

A of FIG. 12 illustrates a state in which one scene of a drama in which three persons M1, M2, and F1 appear is displayed on a screen of a television receiver.

In A of FIG. 12, the person M1 is displayed near a center of the screen, and the person M2 is displayed on a left side of the person M1. Moreover, the person F1 is displayed at a distant position on a right side of the person M1.

In A of FIG. 12, the person M1 says “She is always late”, and the person F1 says “That's not true! That's not . . . ”.

B of FIG. 12 illustrates how the scene illustrated in A of FIG. 12 is displayed in the display area of the HMD.

When such a video is watched on the HMD, if the size of the video is larger than the size of the display area of the HMD, depending on the visual field (head direction) of the user, the person F1 is located outside the display area DA as illustrated in B of FIG. 12.

In B of FIG. 12, in the display area DA, a balloon 151 displaying a sentence “She is always late” representing a conversation of the person M1 is displayed in an upper right of the person M1. Furthermore, originally, in the display area DA, a balloon 152 displaying a sentence “No, that's not true! That's not . . . ” representing a conversation of the person F1 is to be displayed, but since the person F1 is located outside the display area DA, the balloon 152 is not displayed.

Thus, depending on the visual field of the user, part of people and their conversations may become invisible, and it may be difficult to understand development of the drama.

(Example of the Present Technology)

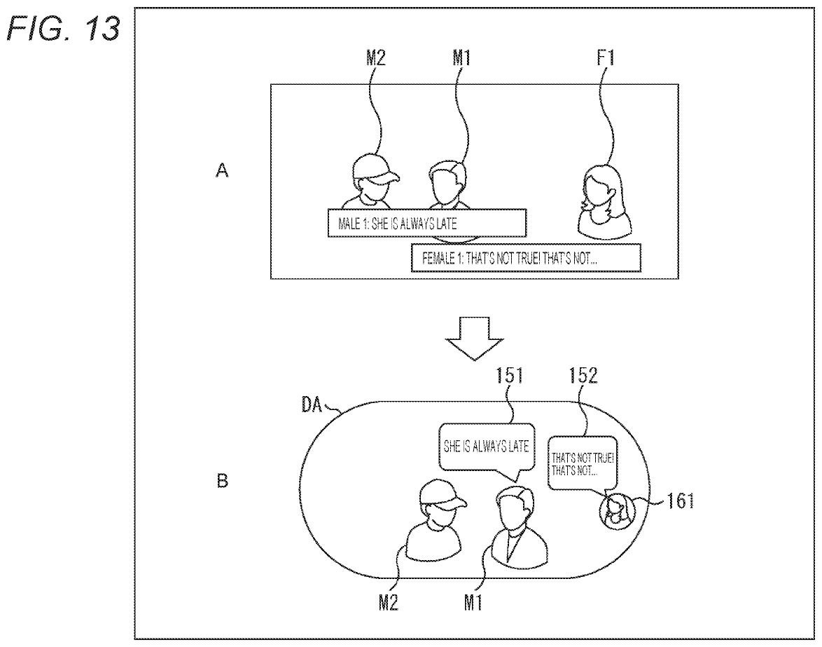

FIG. 13 is a diagram describing a display example of a content image on the HMD 10 of the present technology.

A of FIG. 13 illustrates one scene of a drama similar to A of FIG. 12.

B of FIG. 13 illustrates how the scene illustrated in A of FIG. 13 is displayed in the display area DA of the HMD 10 of the present technology.

Also in B of FIG. 13, the person F1 is located outside the display area DA depending on the visual field (head direction) of the user.

However, in the example of FIG. 13, the balloon 152 representing the conversation of the person F1 and a reduced object 161 in which the area including the person F1 is cut out in a circular shape and reduced are displayed in the display area DA. At this time, in the display area DA, the balloon 151 representing the conversation of the person M1 is moved and displayed directly above the person M1 so as to secure an area in which the balloon 152 is displayed.

Thus, it is possible to easily understand the development of the drama without missing the person located outside the display area and the conversation thereof.

As described above, even when part of objects is located outside the display area depending on the visual field of the user, it is possible to display the character string at the optimal position without failing in transmitting necessary information to the user.

Furthermore, according to the example of FIG. 13, it is possible to let the user know that the person F1 is present on the right side of the display area DA, and guide the user to move the visual field to the right side (turn the head rightward).

### 5. Fourth Display Example

As described above, in a case where an object is located outside the display area, a character string or a reduced object of the object can be displayed in the display area to thereby guide the visual field of the user.

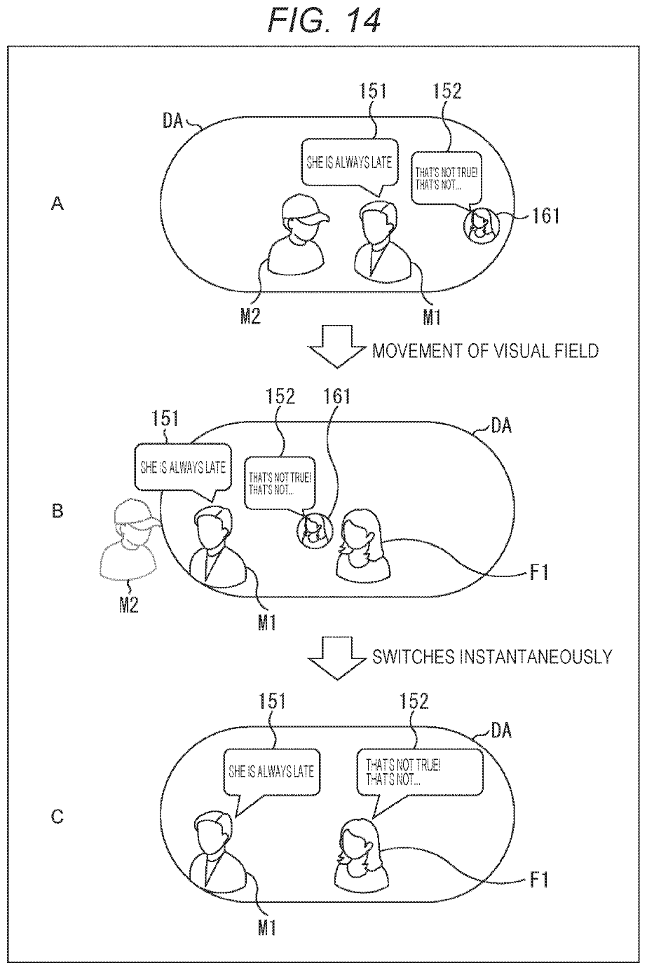

FIG. 14 illustrates an example in which the visual field is guided to an object outside the display area.

A of FIG. 14 illustrates a state similar to B of FIG. 13.

When the user turns his or her head rightward in order to move the visual field from the state in A of FIG. 14, the persons M1, M2 move leftward in the display area DA. As illustrated in B of FIG. 14, the person M1 is located at the left end of the display area DA, and the person M2 is located outside (left side) thereof.

Furthermore, in B of FIG. 14, the person F1 located outside (right side) of the display area DA in A of FIG. 14 is located near the center of the display area DA together with the balloon 152 and the reduced object 161.

Thereafter, the display in the display area DA is instantaneously switched from a state in B to a state in C of FIG. 14.

Specifically, accompanying the movement of the person M1 in the display area DA, the balloon 151, which has been almost out of the display area DA in the state in B of FIG. 14, moves rightward in the display area DA. Furthermore, the reduced object 161 displayed in the state in B of FIG. 14 disappears, and the balloon 152 representing the conversation of the person F1 moves rightward in the display area DA.

Furthermore, the display in the display area DA may be gradually switched from the state in B to the state in C of FIG. 14.

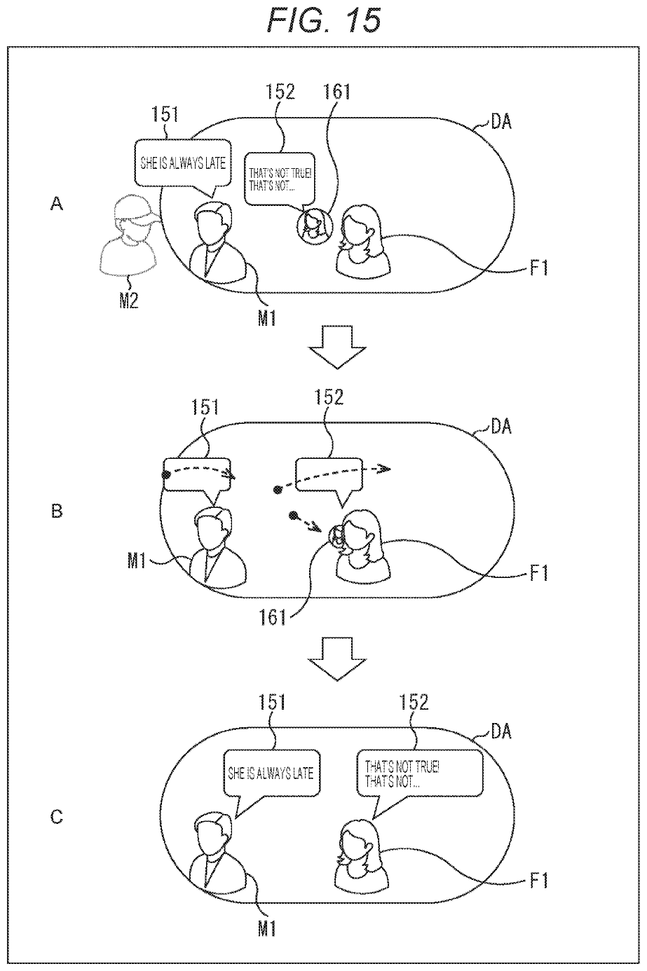

FIG. 15 illustrates an example of how to switch from the state in B to the state in C of FIG. 14.

A state in A of FIG. 15 corresponds to the state in B of FIG. 14, and a state in C of FIG. 15 corresponds to the state in C of FIG. 14.

That is, when the state in A of FIG. 15 is switched to the state in C, as illustrated in a state in B, how the balloon 151 and the balloon 152 move rightward in the display area DA is displayed by animation. Furthermore, how the reduced object 161 hides itself behind the person F1 while being reduced in size is displayed by animation.

By such a manner of switching display, it is easy to understand how the display content changes even when the user suddenly changes the visual field.

### 6. Others

(Other Functional Configuration Example of HMD)

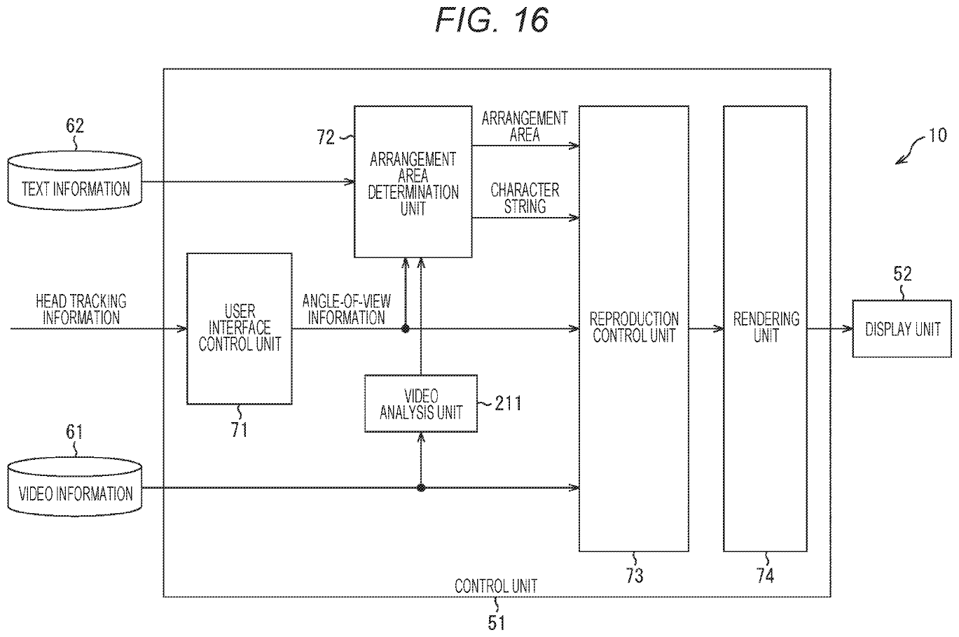

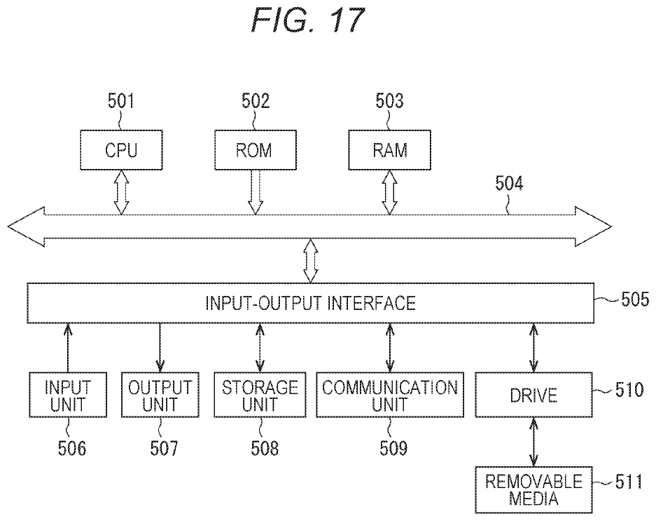

FIG. 16 is a block diagram illustrating another functional configuration example of the HMD 10 described above.

The HMD 10 of FIG. 16 is provided with a video analysis unit 211 in the control unit 51 in addition to the configuration of the HMD 10 of FIG. 3.

The video analysis unit 211 analyzes the video information 61 to detect a target (object) such as a person that is desired to be not hidden by a character string, and supplies object information indicating the detected object to the arrangement area determination unit 72.

In this case, the arrangement area determination unit 72 determines the position and shape of the arrangement area in the display area on the basis of the text information 62, the angle-of-view information from the user interface control unit 71, and the object information from the video analysis unit 211.

With such a configuration as well, the character string is displayed at an optimal position in the content image.

In the above description, the text information 62 is described as being prepared in association with the video information 61, but it may be prepared separately.

In this case, when the character string represented by the text information 62 is superimposed and displayed on a real-time video, the text information 62 and the object are associated with each other in advance. Thus, it is possible to reduce the time required to determine the arrangement area in which the character string is arranged.

Furthermore, although an example in which the present technology is applied to the display device for VR has been described above, the present technology may be applied to a display device for AR. Specifically, the arrangement area in the display area may be determined on the basis of the position of a real object in a real space with respect to the display area.

(Configuration Example of Computer)

The series of processes described above can be executed by hardware or can be executed by software. In a case where the series of processes is executed by software, a program constituting the software is installed in a computer. Here, the computer includes a computer incorporated in dedicated hardware, a general-purpose personal computer for example that can execute various functions by installing various programs, and the like.

FIG. 17 is a block diagram illustrating a configuration example of hardware of a computer that executes the above-described series of processes by a program.

In the computer, a central processing unit (CPU) 501, a read only memory (ROM) 502, and a random access memory (RAM) 503 are interconnected via a bus 504.

An input-output interface 505 is further connected to the bus 504. An input unit 506, an output unit 507, a storage unit 508, a communication unit 509, and a drive 510 are connected to the input-output interface 505.

The input unit 506 includes a keyboard, a mouse, a microphone, and the like. The output unit 507 includes a display, a speaker, and the like. The storage unit 508 includes a hard disk, a nonvolatile memory, and the like. The communication unit 509 includes, for example, a network interface and the like. The drive 510 drives a removable medium 511 such as a magnetic disk, an optical disk, a magneto-optical disk, or a semiconductor memory.

In the computer configured as described above, the CPU 501 loads, for example, a program stored in the storage unit 508 into the RAM 503 via the input-output interface 505 and the bus 504, and executes the program, so as to perform the above-described series of processes.

The program executed by the computer (CPU 501) can be provided by being recorded on, for example, a removable medium 511 as a package medium or the like. Furthermore, the program can be provided via a wired or wireless transmission medium such as a local area network, the Internet, or digital satellite broadcasting.

In the computer, the program can be installed in the storage unit 508 via the input-output interface 505 by mounting the removable medium 511 to the drive 510. Furthermore, the program can be received by the communication unit 509 via a wired or wireless transmission medium and installed in the storage unit 508. In addition, the program can be installed in the ROM 502 or the storage unit 508 in advance.

Note that the program executed by the computer may be a program for processing in time series in the order described in the present description, or a program for processing in parallel or at a necessary timing such as when a call is made.

Note that the embodiments of the present technology are not limited to the above-described embodiments, and various modifications are possible without departing from the scope of the present technology.

Furthermore, the effects described in the present description are merely examples and are not limited, and other effects may be provided.

Moreover, the present technology can have configurations as follows.

(1)

An information processing device including

a control unit that controls display of a character string represented by text information related to an object included in a content image displayed in a display area,

in which the control unit determines an arrangement area in which the character string is arranged in the display area, on the basis of a position of the object with respect to the display area.

(2)

The information processing device according to (1), in which

the control unit determines the arrangement area so as to avoid an area of the object.

(3)

The information processing device according to (1) or (2), in which

the control unit determines the arrangement area near a central visual field of a user in the display area.

(4)

The information processing device according to any one of (1) to (3), in which

the control unit moves a position of the arrangement area according to movement of the object in the display area.

(5)

The information processing device according to (4), in which

the control unit moves the position of the arrangement area according to a change in direction of a head of the user.

(6)

The information processing device according to (4) or (5), in which

the control unit moves the position of the arrangement area with respect to the object in the display area in a direction opposite to a moving direction of the object.

(7)

The information processing device according to any one of (4) to (6), in which

the control unit changes a shape of the arrangement area according to the position of the object moving in the display area.

(8)

The information processing device according to (7), in which

when the object is located near a central visual field of the user in the display area, the control unit changes the shape of the arrangement area so as to avoid an area of the object.

(9)

The information processing device according to (7) or (8), in which

the control unit changes a number of rows of the character string arranged in the arrangement area according to the shape of the arrangement area.

(10)

The information processing device according to (4), in which

the control unit moves the position of the arrangement area for a second object in response to movement of a first object in the display area.

(11)

The information processing device according to (10), in which

when the first object is a person, the control unit moves the position of the arrangement area for the second object so as to avoid at least a face area of the person.

(12)

The information processing device according to (4), in which

when a size of the content image is larger than a size of the display area, the control unit moves the arrangement area into the display area.

(13)

The information processing device according to (12), in which

when the object is located outside the display area, the control unit moves the arrangement area into the display area.

(14)

The information processing device according to (13), in which

the control unit displays a reduced object, which is obtained by reducing the object located outside the display area, near the arrangement area determined in the display area.

(15)

The information processing device according to (13) or (14), in which

the control unit displays, by animation, movement of the position of the arrangement area in the display area accompanying movement of the object from outside the display area into the display area.

(16)

The information processing device according to any one of (1) to (15), in which

the control unit displays a balloon in which the character string is displayed in the arrangement area.

(17)

The information processing device according to any one of (1) to (16), in which

the text information includes position information indicating a position that is possible to be determined as the arrangement area in the display area, and

the control unit determines the arrangement area using the position information.

(18)

The information processing device according to (17), in which

the text information further includes priority information indicating priority of positions that are possible to be determined as the arrangement area, and

the control unit determines the arrangement area using the position information and the priority information.

(19)

An information processing method including, by an information processing device:

controlling display of a character string represented by text information related to an object included in a content image displayed in a display area; and

determining an arrangement area in which the character string is arranged in the display area, on the basis of a position of the object with respect to the display area.

(20)

A program causing a computer to execute:

controlling display of a character string represented by text information related to an object included in a content image displayed in a display area; and

determining an arrangement area in which the character string is arranged in the display area, on the basis of a position of the object with respect to the display area.

### REFERENCE SIGNS LIST

10 HMD
51 Control unit
52 Display unit
61 Video information
62 Text information
71 User interface control unit
72 Arrangement area determination unit
73 Reproduction control unit
74 Rendering unit
211 Video analysis unit

1. An information processing device comprising
a control unit that controls display of a character string represented by text information related to an object included in a content image displayed in a display area,
wherein the control unit determines an arrangement area in which the character string is arranged in the display area, on a basis of a position of the object with respect to the display area.

2. The information processing device according to claim 1, wherein
the control unit determines the arrangement area so as to avoid an area of the object.

3. The information processing device according to claim 1, wherein
the control unit determines the arrangement area near a central visual field of a user in the display area.

4. The information processing device according to claim 1, wherein
the control unit moves a position of the arrangement area according to movement of the object in the display area.

5. The information processing device according to claim 4, wherein
the control unit moves the position of the arrangement area according to a change in direction of a head of the user.

6. The information processing device according to claim 4, wherein
the control unit moves the position of the arrangement area with respect to the object in the display area in a direction opposite to a moving direction of the object.

7. The information processing device according to claim 4, wherein
the control unit changes a shape of the arrangement area according to the position of the object moving in the display area.

8. The information processing device according to claim 7, wherein
when the object is located near a central visual field of the user in the display area, the control unit changes the shape of the arrangement area so as to avoid an area of the object.

9. The information processing device according to claim 7, wherein
the control unit changes a number of rows of the character string arranged in the arrangement area according to the shape of the arrangement area.

10. The information processing device according to claim 4, wherein
the control unit moves the position of the arrangement area for a second object in response to movement of a first object in the display area.

11. The information processing device according to claim 10, wherein
when the first object is a person, the control unit moves the position of the arrangement area for the second object so as to avoid at least a face area of the person.

12. The information processing device according to claim 4, wherein
when a size of the content image is larger than a size of the display area, the control unit moves the arrangement area into the display area.

13. The information processing device according to claim 12, wherein
when the object is located outside the display area, the control unit moves the arrangement area into the display area.

14. The information processing device according to claim 13, wherein
the control unit displays a reduced object, which is obtained by reducing the object located outside the display area, near the arrangement area determined in the display area.

15. The information processing device according to claim 13, wherein
the control unit displays, by animation, movement of the position of the arrangement area in the display area accompanying movement of the object from outside the display area into the display area.

16. The information processing device according to claim 1, wherein
the control unit displays a balloon in which the character string is displayed in the arrangement area.

17. The information processing device according to claim 1, wherein
the text information includes position information indicating a position that is possible to be determined as the arrangement area in the display area, and
the control unit determines the arrangement area using the position information.

18. The information processing device according to claim 17, wherein
the text information further includes priority information indicating priority of positions that are possible to be determined as the arrangement area, and
the control unit determines the arrangement area using the position information and the priority information.

19. An information processing method comprising, by an information processing device:
controlling display of a character string represented by text information related to an object included in a content image displayed in a display area; and
determining an arrangement area in which the character string is arranged in the display area, on a basis of a position of the object with respect to the display area.

20. A program causing a computer to execute:
controlling display of a character string represented by text information related to an object included in a content image displayed in a display area; and
determining an arrangement area in which the character string is arranged in the display area, on a basis of a position of the object with respect to the display area.
